(19) United States
(12) Patent Application Publication
(10) Pub. No.: US 2021/0327305 A1
(43) Pub. Date: Oct. 21, 2021

(54) SYSTEM FOR VALIDATING AND TRAINING INVASIVE INTERVENTIONS

(71) Applicant: PHACON GMBH, Leipzig (DE)

(72) Inventors: Robert HAASE, Leipzig (DE); Hendrik MOECKEL, Leipzig (DE)

(21) Appl. No.: 17/265,372

(22) PCT Filed: Jul. 29, 2019
(86) PCT No.: PCT/EP2019/070345

§ 371 Date: Feb. 2, 2021

(30) Foreign Application Priority Data
Aug. 3, 2018 (DE) 10 2018 118 918.4

(51) Int. Cl. G09B 23/30

(52) U.S. Cl. CPC G09B 23/303; G09B 23/306

(57) ABSTRACT

The invention relates to a system for validation and training in invasive interventions in human and veterinary medicine, comprising a training model with an anatomical reproduction of a body part and an interchangeable practice region. The system additionally has a fluid circuit with a fluid reservoir, a pump unit, and a tube system. Interventions in the interchangeable practice region are monitored by a detection device. The user's interaction with the anatomically modeled parts of the interchangeable practice region triggers an autonomous reaction and control of the pump unit as a result of an increase or a decrease in the voltage, the current, or the frequency of the pump, said increase or decrease being generated by feedback electrical signals. The invention additionally relates to a method for validation and training in invasive interventions in human and veterinary medicine, wherein contact with the anatomically modeled parts of the interchangeable practice region is detected by the detection device, which is embodied as an electrically conductive structure and/or a light-guiding structure, and lastly the voltage, the current, or the frequency of the at least one pump is varied.

The invention relates to a system for validation and training in invasive interventions in human and veterinary medicine.

Parameters and scenario-dependent control signals are established which provide information on learning success and quality and thus provide a performance control of the intervention being practiced. The interventions being practiced include surgical and minimally invasive surgical techniques by means of operative instruments such as, for example, the placement of implants or cannulas, in which training is administered under realistic conditions on the training model.

The system comprises a training model that anatomically replicates the human or animal body, a fluid circuit having at least one fluid reservoir, at least one pump unit, and a tube system as well as a detection device.

The object of the present method is validation of and training in operative interventions with the aid of the system according to the invention.

Training models that were published previously are used for vascular applications which include but are not limited to the puncturing of vessels in order to practice operations, blood collection, or injections, for example.

EP 0 990 227 B1 describes a surgical training device. This has a housing in the form of a closed container that is similar to an abdominal cavity, for example, in which reproductions of blood vessels, for example, can be arranged. The container is also provided with a pump that simulates a bloodstream through arteries and veins and provides blood flow through arteries, for example. The fluid used for this purpose is pressurized.

DE 42 12 908 A1 discloses a surgical simulation model, particularly of the abdominal cavity and for laparoscopic interventions, in which parts of the blood circuit can be disposed as a circulating fluid circuit, among other things. Lines for electric current, fluids, gas, or light have access to the outside. For instance, nerves are represented as a circuit that conducts electric current. The body cavity itself can be sealed in a gas-tight and/or fluid-tight manner.

GB 2 338 582 A describes a surgical simulator for endovascular interventions. To this end, the simulator has an anatomically shaped torso with an opening in the abdominal region in which the body part to be treated is positioned—e.g., kidneys or an interchangeable, transparent replica of the aorta through which a fluid is pumped. The torso further comprises openings in the inguinal region for inserting endovascular stent transplants. The simulator also includes diversely embodied interchangeable plates that can be placed in a form-fitting manner onto the opening of the cavity in the abdominal region of the torso in order to seal it off. Here, the plates serve as skin imitations and are transparent in order to enable visual observation.

U.S. Pat. No. 4,182,054 A discloses a phantom arm composed of a hollow component in the form of a human arm. The phantom arm has grooves in the region of the wrist and the bend of the elbow in which tubes run as replicated arteries that are composed of an elastic tube. The phantom arm and, in particular, the flexible tubing running in the grooves are coated with an artificial latex skin made of elastic material. At anatomically predefined puncture sites, the body is hollowed out beneath the latex skin. The flexible tubing is connected to a fluid container with artificial blood that is arranged above the arm in order to produce the required pressure in the flexible tubing. This pressure can also be generated by a periodically operating pump.

DE 20 2009 004 115 U1 describes models for training in invasive techniques in which reproductions of blood vessels made of silicone tubes are embedded. Blood vessels are to be palpated and punctured, and errors in handling are intended to result in bleeding and hematomas. The blood vessels are under pulsing blood pressure, although it is not disclosed how this is to be achieved.

Pumps for simulating injuries to vessels are known which are controlled in such a way that they pump more blood into the vessel as a function of the type of injury and the person practicing must seal the wound again.

An anatomical simulator for videoscopic surgical training is known from U.S. Pat. No. 5,620,326 A which comprises a plurality of synthetic anatomical structures and an elastic and flexible synthetic connective tissue that binds the synthetic and anatomical structures together and constitutes a synthetic layer of tissue with a predefined tensile strength. The simulator is used to learn how to dissect an anatomical structure, with the other anatomical structures remaining intact as the procedure is carried out properly. The structures and connective tissue are embedded in a fluid container with synthetic bodily fluid that can be covered with an artificial body part made of hard material in order to approximate true-to-life dissection conditions. Continuous blood circulation is simulated by means of a pump. If a tube is struck during training, there is greater flow of fluid through the vessel until it is sutured.

A very similar model for practicing the puncturing of blood vessels and/or vascular resection in various anatomical reproductions is described in DE 44 14 832 A1. A ball pump simulates the pulse. The blood vessels can be palpated and are made of a soft, flexible plastic material such as polyurethane, for example, that is self-sealing and automatically seals an opening that occurs as a result of the insertion of a cannula after the cannula is withdrawn.

DD 230 664 A3 discloses a practice phantom in the form of a human body with imitated blood circulation. Arterial and venous bleeding is simulated at various sites of the body, and a palpable pulse is simulated in the neck region. This is achieved through flexible tubing that has sealable openings to simulate bleeding sites as well as locking elements for blocking certain parts of the tubing system. The locking elements are connected to a control unit that is arranged in the body part of the phantom with a fluid pump. The practice phantom is intended to enable inferences about the patient's general condition based, among other things, on the type and intensity of bleeding that occurs and the frequency of the pulse.

DE 10 2016 225 167 A1 discloses an ex vivo pulmonary circulation and ventilation device for training in surgical and minimally invasive surgical interventions. The device comprises for this purpose a gas-tight container for receiving an organic tissue such as a lung. The lung is ventilated via a ventilation tube. The pressure control and air leakage measurement is performed by means of a drainage tube. Bodily fluid such as blood coming from a fluid circuit, for example, is conducted via perfusion tubes into the pulmonary artery and flows over the pulmonary vein, which is arranged more deeply as a result of the inclination of the container, and via an outlet back into the fluid circuit.

Document DE 10 2015 008 050 A1 shows a model system of a blood circuit in which the blood flow for non-invasive transabdominal plethysmography is realistically simulated with two different and independently adjustable blood circuits (maternal and fetal) with differing pulse shapes and pulse frequencies. US 2014/0272872 A1 shows a similarly designed training model with the simulation of blood circulation in which the blood flow is also simulated by means of pumps. In US 2014/0127663 A1, a training simulator is used to simulate various scenarios on an anatomical replica of the human body, including, inter alia, the vital functions of a newborn.

However, the disadvantage of the training models that are known from the prior art is that they do not have realistic scenarios that are associated, for example, with an increased adrenaline output or an increased pulse rate. The pulse rate corresponds to the heart rate. Since the training models that are known from the prior art only simulate blood circulation, the scenarios cannot be adapted to individual injuries, for example in the case of exsanguination due to an injury to risk structures.

The parameters of the blood circulation and other patient data cannot be individually adapted to the respective patient with regard to their anatomy or their age.

The documents disclosed thus far do not describe, for example, how the pump recognizes that it needs to pump harder. The interaction of the surgical instrument with blood vessels or other vessels such as nerve conduits is also not adequately disclosed in the prior art.

It is therefore the object to provide a system that overcomes the drawbacks of the prior art.

A training system is to be provided which is suitable and adapted and designed for the validation of and training in differently designed invasive and surgical interventions in human and veterinary medicine. This individual configuration of the training system is intended to ensure effective, specialized, and focused training that is to be implemented by means of control and monitoring that is appropriately adapted to the training being carried out.

It would also be highly desirable for the system to react in real time to injuries or the reaching of certain positions or structures in order to provide a realistic scenario for the user.

According to the invention, the object is achieved by a system for validation and training in invasive interventions in human and veterinary medicine according to the independent claims. Advantageous embodiments of the invention are indicated in the dependent claims.

A first aspect of the invention relates to a system for validation and training in invasive interventions in human and veterinary medicine, said system comprising a training model that is anatomically modeled from the human or animal body. The training model has an anatomical replica of a body part of the human or animal body with an opening and an anatomical replica of an interchangeable practice region that can be inserted into the opening of the anatomical replica of the body part, has a front side that is accessible from the outside, a rear side that is at least partially connected in a form-fitting manner to the opening of the anatomical replica of the body part, and comprises anatomically replicated components such as at least one artificial blood vessel that are arranged in or on the interchangeable practice region. Furthermore, the system according to the invention comprises a fluid circuit having at least one fluid reservoir containing a fluid, at least one pump unit for generating a heartbeat and pulse based on the human cardiovascular system in the at least one artificial blood vessel, the pump unit having at least one pump for conveying the fluid in the fluid circuit and the at least one artificial blood vessel and for simulating the blood flow and the pulse, and having a control unit that is coupled to the at least one pump, and a tube system. The tube system comprises at least two first tubes, one end of each of which is detachably connected to the end of each of the at least one artificial blood vessel and the other end of each of which is detachably connected to the at least one pump of the pump unit and serves as the first feed and as the first return.

The system according to the invention also has at least one electronic control, measurement, and evaluation unit and at least one detection device for monitoring the interventions in the interchangeable practice region, the at least one detection device being arranged in or on the anatomically modeled components of the interchangeable practice region and connected to the control unit of the pump unit via signal transmission means, the system being embodied such that the detection device detects an interaction of the user with the anatomically modeled components of the interchangeable practice region, and the data generated by the interaction as feedback electrical signals via the signal transmission means are transmitted to the electronic control, measurement, and evaluation unit, whereupon the electronic control, measurement, and evaluation unit analyzes the data and, on that basis, transmits a scenario-dependent control signal via the signal transmission means to the control unit of the pump unit, whereby an autonomous reaction and control of the at least one pump unit takes place as a result of an increase or a decrease in the voltage, the current, or the frequency of the at least one pump.

Another aspect of the invention relates to a method for validation and training in invasive interventions in human and veterinary medicine using the system according to the invention.

In one embodiment, the entire system according to the invention, or at least the components relevant thereto, is sterile. This advantageously provides a realistic training opportunity. For the purposes of the invention, components are understood to mean all components of the system such as the training model with anatomically modeled body part and interchangeable practice region and components thereof, the fluid circuit such as the fluid reservoir, pump unit, and tube system and components thereof, the detection device, the sensors, and the electronic measurement, control, and evaluation unit.

In embodiments, the system according to the invention is designed to be portable and compact. It can therefore be advantageously used quickly and anywhere.

In one embodiment, the system according to the invention has a modular design. Individual components can thus be advantageously interchanged depending on requirements and the application or in case of repairs, whereby various scenarios can be carried out flexibly and individual components can be added or removed easily and in a user-friendly manner. The system according to the invention also advantageously functions independently and autonomously depending on the events that have occurred. An operator who controls the scenario, for example, is not necessary.

The system according to the invention comprises a training model that is anatomically modeled from the human or animal body.

The training model is used by the user, hereinafter also referred to as the operator, surgeon, or doctor, for validation and training of invasive interventions in human and veterinary medicine.

In one embodiment, the system is embodied as a simulation system. Surgical and minimally invasive surgical techniques are simulated and tested by simulating real anatomical and functional conditions on the patient during a surgical or minimally invasive surgical procedure. The training model equates to a patient who is to be treated by the user in the real case.

The training model is a precise and anatomically accurate replica of a human or animal body.

According to the invention, the training model has an anatomical replica of a body part and an anatomical replica of an interchangeable practice region.

In embodiments, the training model has a collecting tray. In the event of an injury to the at least one artificial blood vessel, fluid that escapes is advantageously caught by the collecting tray and does not cause any soiling. In addition, the collected fluid can be reused. In one embodiment, the training model is stored and arranged in the collecting tray. In an alternative embodiment, at least the interchangeable practice region of the training model is stored and arranged in the collecting tray.

According to the invention, the system comprises an anatomical replica of a body part of the human or animal body. In the context of the invention, the term “anatomical replica of the body part” denotes various body parts, all of which can be anatomically replicated. A body part is understood to be a segment of the body that is morphologically recognizable as a functional unit. These include, for example, the leg, arm, pelvis, head, or spinal column.

In embodiments, the anatomical replica of the body part of a patient has different configurations. The correspondingly simulated human or animal body part is simulated in an anatomically precise and realistic manner. The type of configuration of the body part is based on various factors, such as, for example, the modeled age of the patient to be examined and/or the corresponding anatomy. Each and every body part of a person or animal can be represented as an anatomical replica of the body part.

The size of the anatomical replica of the body part of a person relates in the context of the invention to any size of a body part that a person, whether male or female, can have in the course of his or her life. In one embodiment, the size of the body part relates to the simulated realistic anatomy of an average adult man or an average adult woman. In a further embodiment of the invention, the size of the body part relates to a child and corresponds to the size of the body part of the respectively simulated realistic anatomy of a child. For the purposes of the invention, the size of the body part of an animal denotes any body part size that an animal, whether male or female, can have in the course of its life. In an alternative embodiment of the invention, the size of the body part is smaller or larger than the simulated realistic anatomy of a person or animal.

Furthermore, the type of configuration of the anatomical replica of the body part is based on the course of the disease and/or the stage of the disease of the patient to be examined. In embodiments, the anatomical replica of the body part is embodied as an anatomical replica of the skull. In preferred embodiments, the anatomical replica of the body part is embodied as an anatomical replica of the arm, very especially preferably as an anatomical replica of the human forearm.

According to the invention, the anatomical replica of the body part has an opening. In the context of the invention, an opening is understood to mean a recessed space or a hollow or a cavity in the anatomical replica of the body part. The opening can have different dimensions and is adapted to the size of the body part. In embodiments, the opening is located anywhere in the anatomical replica of the body part and is not limited to certain areas.

In embodiments, if the anatomical replica of the body part is embodied as a skull, the opening is located in the area of the petrous bone region of the skull. In alternative embodiments, the opening is located in the area of the nasal bone region of the skull. In further alternative embodiments, the opening is located in the area of the skull.

In further embodiments, if the anatomical replica of the body part is embodied as an arm, preferably as a forearm, an opening is located in the area of the radial and ulnar arteries.

In further embodiments, if the anatomical replica of the body part is embodied as a back region, the opening is located in the area of the spinal column. Either the entire spinal column can be shown or only a portion thereof, such as the cervical, thoracic, or lumbar spine.

According to the invention, the system comprises an anatomical replica of an interchangeable practice region, referred to below as an interchangeable practice region.

According to the invention, the interchangeable practice region is designed to be inserted into the opening of the anatomical replica of the body part. In one embodiment, the interchangeable practice region is designed in such a way that it can be inserted in a form-fitting manner into the opening of the anatomical replica of the body part.

In further embodiments, the interchangeable practice region is designed to be detachable in a form-fitting manner in the opening of the anatomical replica of the body part. In one embodiment, the interchangeable practice region is mechanically connected to the anatomical replica of the body part.

In embodiments, the opening of the anatomical replica of the body part is adapted to the size of the interchangeable practice region that can be used. The opening in the anatomical replica of the body part corresponds to a space into which at least a portion of the interchangeable practice region can be inserted. In one embodiment, the interchangeable practice region is releasably connected to the anatomical replica of the body part.

“Interchangeable practice region” is understood to mean an anatomical replica of a body region that is anatomically, topographically, and functionally correlated to the corresponding defined anatomical replica of the body part. The practice region is designed to be interchangeable. In one embodiment, each and every body region of a human or animal can be represented as an interchangeable practice region.

In embodiments, the interchangeable practice region is embodied as a petrous bone, in particular as a precise anatomical replica of the human petrous bone region, that can be inserted into a skull. In further embodiments, the interchangeable practice region is embodied as a precise anatomical replica of the nasal bone region that can be inserted into a skull.

In a preferred embodiment, the interchangeable practice region is embodied as a precise anatomical replica of an arm segment, in one especially preferred embodiment a forearm segment that can be inserted into the opening in the area of the radial and ulnar arteries.

In an alternative embodiment, the interchangeable practice region is embodied as a precise anatomical replica of a spinal column segment that can be inserted into the opening in the back region. Either the entire spinal column can be shown or only a portion thereof, such as the cervical, thoracic, or lumbar spine.

The type of configuration of the interchangeable practice region is based on various factors such as the modeled age of the patient and/or the corresponding anatomy.

The size of the interchangeable practice region of a person relates in terms of the invention to any size of the interchangeable practice region that a person, regardless of whether male or female, can have in the course of his or her life. In one embodiment, the size of the interchangeable practice region relates to the replicated realistic anatomy of an average adult male or female. In a further embodiment of the invention, the size of the interchangeable practice region relates to the simulated realistic anatomy of a child and corresponds to the size of the anatomy of the respective child's age. For the purposes of the invention, the size of the interchangeable practice region of an animal denotes any size of the interchangeable practice region that an animal, whether male or female, may have in the course of its life. In an alternative embodiment of the invention, the size of the interchangeable practice region is smaller or larger than the simulated realistic anatomy in a person or in an animal.

Furthermore, the type of configuration of the interchangeable practice region is based on the course of the disease and/or the stage of the disease of the patient to be examined.

According to the invention, the interchangeable practice region has a front side. In embodiments, the front side of the interchangeable practice region presents a surface that faces outward and is exposed. For the purposes of the invention, “outside” means the environment of the system from which the user has free access to the practice region. According to the invention, the front side of the interchangeable practice region is accessible to the user from the outside, meaning that operative instruments and/or implants are inserted through the front side into the interchangeable practice region. The front side of the interchangeable practice region thus represents the access area for the user during training.

In one embodiment, prior to the introduction of surgical instruments and/or implants, the interchangeable practice region is opened by a surgical method using surgical instruments. In this way, the opening of the interchangeable practice region is advantageously practiced before the introduction of an implant, for example.

According to the invention, the interchangeable practice region has a rear side.

In embodiments, the rear side of the interchangeable practice region represents a surface that is directed inward, i.e., for the anatomical reproduction of the body part, and not accessible from the outside for the user.

In one embodiment, the rear side of the interchangeable practice region is at least partially in physical contact with the anatomical replica of the body part. According to the invention, physical contact is understood to mean a form-fitting connection. In embodiments, the back side of the interchangeable practice region is at least partially in physical contact with the opening of the anatomical replica of the body part.

According to the invention, the rear side of the interchangeable practice region is at least partially connected in a form-fitting manner to the opening of the anatomical replica of the body part. In one embodiment, the rear side of the interchangeable practice region is in physical contact with the opening of the anatomical replica of the body part.

In embodiments, the rear side of the interchangeable practice region is at least partially in physical contact with the anatomical replica of the body part. In further embodiments, the rear side of the interchangeable practice region is not accessible to the user from the outside.

Furthermore, the anatomical replica of an interchangeable practice region is claimed. In a preferred embodiment, the anatomical simulation of an interchangeable practice region comprises anatomically modeled components such as at least one artificial blood vessel and/or nerve tissue and/or a skin covering which are arranged in or on the interchangeable practice region.

According to the invention, the interchangeable practice region comprises anatomically modeled components such as at least one artificial blood vessel. Furthermore, according to the invention, the anatomically modeled components are arranged in or on the interchangeable practice region.

These are artificial blood vessels in every conceivable anatomical replica of a body part, such as the petrous bone, nasal bone, or forearm region.

In one embodiment, the anatomically modeled components of the interchangeable practice region are at least partially transparent. The user can then advantageously better observe the processes taking place there. In an alternative embodiment, the anatomically modeled components of the interchangeable practice region are at least partially realistic and therefore not transparent. This advantageously provides the user with a more realistic training situation.

In embodiments, the anatomically modeled components of the interchangeable practice region can be easily perceived haptically and/or optically by the user of the system according to the invention.

In embodiments, the anatomically modeled components of the interchangeable practice region are at least partially sterile.

In one embodiment, the anatomically modeled component of the interchangeable practice region is embodied as an anatomical reproduction of human or animal vessels. In embodiments, the at least one artificial vessel is embodied as an anatomical replica of human or animal vessels and is also referred to as an artificial blood vessel. In further embodiments, the at least one artificial blood vessel is embodied as an anatomical replica of vessels of an adult or child. The at least one artificial blood vessel is embodied as an artery, vein, or capillary. In a further embodiment, the anatomically modeled components of the interchangeable practice region have more than one artificial blood vessel, preferably a network of artificial blood vessels. The user can advantageously readily perceive the at least one artificial blood vessel visually as well as its haptic quality.

In embodiments, the at least one artificial blood vessel embodied as an anatomically modeled component is to be regarded as part of the fluid cycle, so that in the following steps that relate to the fluid cycle, the anatomically modeled components such as the at least one artificial blood vessel are also included.

In a further embodiment, the anatomically modeled components of the interchangeable practice region include, in addition to or instead of artificial blood vessels, other anatomical reproductions of vessels such as, for example, artificial lymphatic vessels, the artificial lymphatic vessels being embodied as lymph capillaries, collectors, or lymphatic collecting trunks. In the following, all listed specifications of the artificial blood vessels also refer to all vessel types, including the artificial lymph vessels.

In embodiments, the at least one artificial blood vessel is embodied as a flexible hollow tube.

In one embodiment, the at least one artificial blood vessel is at least partially transparent. This advantageously ensures a good view for the user and good representability for the optoelectronic detection means. In a further embodiment, the at least one artificial blood vessel has variable inner and outer diameters.

In embodiments, the at least one artificial blood vessel is at least partially in physical contact with the interchangeable practice region and/or with the anatomical replica of the body part.

In one embodiment, the at least one artificial blood vessel has variable and lifelike thicknesses and mechanical properties, so that the at least one artificial blood vessel can actually be punctured, cut through, or pierced, for example using surgical instruments and/or implants. Injuries similar to humans can thus be advantageously simulated.

In embodiments, the at least one artificial blood vessel has the mechanical properties and wall thickness of the human or animal vessels of the corresponding body region and can be varied therein. The at least one artificial blood vessel advantageously has an appropriate strength or an appropriate resistance while being simultaneously flexible. In one embodiment, the at least one artificial blood vessel is designed to be expandable. In a further embodiment, the at least one artificial blood vessel consists at least partially of an elastic plastic, preferably of an elastic medical plastic. The elastic plastic of the at least one artificial blood vessel is advantageously designed in such a way that it has a high level of resilience, whereby it can approximate its original shape again after a deformation. In further embodiments, the material of the at least one artificial blood vessel is designed to be self-sealing.

In embodiments, the anatomically modeled component of the interchangeable practice region is embodied as an anatomical reproduction of human or animal nerve tissue.

In further embodiments, the anatomically modeled component of the interchangeable practice region is embodied as a combination of an anatomical reproduction of human or animal vessels and human or animal nerve tissue.

The nerve tissue is advantageously designed in such a way that it has a high level of resilience, whereby it can again approximate its original shape after a deformation.

In a preferred embodiment, the anatomically modeled component of the interchangeable practice region is embodied as an anatomically modeled skin covering. The skin covering equates to an imitation skin. In embodiments, the skin covering of the outermost layer corresponds to at least the front side of the interchangeable practice region.

In a preferred embodiment, the anatomically modeled skin covering is at least partially arranged on the interchangeable practice region. In an alternative embodiment, the anatomically modeled skin covering is arranged at least partially on the anatomical replica of the body part. In a further alternative embodiment, the anatomically modeled skin covering is arranged at least partially on the anatomical reproduction of the body part and/or the interchangeable practice region.

In a preferred embodiment, the anatomically modeled skin covering consists at least partially of elastic plastic. In one embodiment, the skin covering is transparent.

In a further preferred embodiment, the anatomically modeled skin covering has a high level of resilience. The skin covering thus advantageously approaches its original shape again after a deformation.

In embodiments, the skin covering has the mechanical properties and layer thickness of the human or animal skin of the corresponding body region and can be varied therein.

The skin covering advantageously has an appropriate strength or an appropriate resistance while being simultaneously flexible, so that the anatomically modeled components of the interchangeable practice region located underneath can be realistically felt and touched.

In a further preferred embodiment, the anatomically modeled skin covering realizes a haptic perception of the at least one artificial blood vessel located underneath. As a result, punctures and palpations can be advantageously carried out on the interchangeable practice region. In embodiments, the skin covering has different and true-to-life thicknesses and mechanical properties, so that the skin covering can be actually cut through or pierced, for example by means of surgical instruments and/or implants.

In a preferred embodiment, the fluid emerging from the at least one artificial blood vessel collects under the skin covering and can be felt as a simulation of an aneurysm or hematoma.

In one embodiment, the anatomically modeled components of the interchangeable practice region are present individually or in combination. Thus, the anatomically modeled components of the interchangeable practice region can comprise at least one artificial blood vessel and/or anatomically modeled nerve tissue and/or an anatomically modeled skin covering, the at least one artificial blood vessel preferably being present in all configurations.

In embodiments, the training model has at least partially an anatomical replica of muscles and/or fat tissue. In embodiments, the muscles and/or the fatty tissue are arranged at least partially under the skin covering. In embodiments, the muscles and/or the fatty tissue are transparent.

In the context of the invention, the risk structure refers to those components which can be touched or injured or damaged during training. In one embodiment, these anatomical areas covered by the risk structure should not be damaged or injured during use on a living patient, i.e., in reality.

In embodiments, the risk structures of the training model at least partially include areas of the interchangeable training region of the training model. In preferred embodiments, the risk structures of the training model include the anatomically modeled components of the interchangeable practice region, i.e., the at least one artificial blood vessel and/or anatomically modeled nerve tissue and/or an anatomically modeled skin covering. In alternative embodiments, the risk structures of the training model include areas of the anatomical replication of the body part and/or of the interchangeable practice region of the training model.

In embodiments, the risk structures to be examined and/or the anatomical space surrounding the risk structures are at least partially transparent. Advantageously, the user can then better observe the processes taking place there, and a good representability of the processes is guaranteed, which can be easily recorded, for example, by the optoelectronic detection means. In embodiments, plastics such as polyamides or polyurethanes or silicones are used as the transparent material. In alternative embodiments, the risk structures are at least partially realistic and therefore not transparent. This advantageously provides the user with a more realistic training situation.

According to the invention, the system comprises a fluid circuit. The fluid circuit has at least one fluid reservoir, at least one pump unit, and a tube system. In one embodiment, the fluid circuit represents an imitation of the human blood circuit or the human cardiovascular system and hence physiological processes in the human body. According to the invention, the fluid in the fluid circuit is conveyed by at least one pump and one control unit of the pump unit.

In embodiments, the volume of fluid in the fluid circuit corresponds to the real blood volume and hence to the total amount of blood in the human or animal body. In further embodiments, the volume of fluid in the fluid circuit corresponds to the real blood volume and hence to the total amount of blood in the body of an adult or child.

In one embodiment, the fluid reservoir is arranged directly on the pump unit and is detachably connected thereto. In a further embodiment, the fluid reservoir is placed on the pump unit, so that fluid is fed from above into the at least one pump of the pump unit. In embodiments, the fluid is an imitation of a bodily fluid. In embodiments, the fluid corresponds to blood. In alternative embodiments, the fluid corresponds to lymph.

In one embodiment, the fluid is contained in the at least one fluid reservoir. The fluid contained there is conveyed through the fluid circuit via the at least one pump of the pump unit. The fluid is thus conveyed through the at least one artificial blood vessel, through the tube system, and through the at least one pump unit.

According to the invention, the fluid reservoir contains a fluid.

In embodiments, the fluid reservoir is embodied as a tank or storage vessel. In alternative embodiments, the fluid reservoir is anatomically designed. In a further embodiment, the fluid reservoir corresponds to the anatomical replica of the body part or anatomical replica of the interchangeable practice region.

In one embodiment, the fluid reservoir is connected to the pump unit via at least one self-closing quick-release coupling. The fluid reservoir is therefore advantageously mounted or removed quickly, for example for filling with fluid. In an alternative embodiment, the fluid reservoir is detachably connected to at least one pump of the pump unit via a second tube that is embodied as a second feed and a second tube that is embodied as a second return. The fluid reservoir can be at any distance from the pump unit. The second feed and second return have the same function as the first feed and first return.

The fluid from the fluid reservoir is conveyed through the tube system and the at least one artificial blood vessel by the at least one pump of the pump unit.

Advantageously, if the user interacts with the system, the fluid reservoir ensures that fluid is replenished therefrom—until the fluid contained in the fluid reservoir is used up. This advantageously simulates severe blood loss due to a lack of volume in or exsanguination of the patient.

In one embodiment, the fluid reservoir contains a fluid volume in the range from 0 l to 10 l, preferably from 4 l to 7 l, very preferably from 4.5 l to 6 l. The fluid volume is advantageously sufficient to simulate blood loss, the amount of fluid emerging from the at least one artificial blood vessel in the event of an interaction or injury by the user being in a range that simulates severe blood loss up to blood loss with fatal consequences. The volume of the fluid emerging from the at least one artificial blood vessel is therefore preferably no more than approximately 2 l.

According to the invention, the pump unit has at least one pump for conveying the fluid in the fluid circuit and for simulating the blood flow and the pulse, and one control unit.

According to the invention, the at least one pump unit is used to generate a heartbeat and pulse based on the human cardiovascular system in the at least one artificial blood vessel of the interchangeable practice region of the training model.

Furthermore, the pump unit is used to generate a heartbeat and pulse based on the human cardiovascular system in at least one artificial blood vessel, the pump unit having at least one pump and one control unit, the at least one pump being embodied as a spiral pump, centrifugal pump, diaphragm pump, roller pump, shaking pump, water pump, or chain pump.

In one embodiment, the at least one pump unit has a modular structure and comprises at least one pump and one control unit as modules. In further embodiments, the individual modules of the at least one pump unit are interchangeable depending on requirements and the application or in case of repairs. Various scenarios can be advantageously carried out flexibly without replacing the entire pump unit. A pump can be added to or removed from the pump unit quickly and in a user-friendly manner.

The at least one pump unit preferably comprises at least one pump, also called a blood pump. In a preferred embodiment, the at least one pump is embodied as a fluid pump. For this purpose, the at least one fluid pump is designed to operate periodically to convey fluids in the fluid circuit. In this way, the fluid can be advantageously circulated in the fluid circuit.

In embodiments, the at least one pump is used to ventilate the tubes of the tube system and the anatomically modeled components before commencement of the measurement and/or to ventilate the tubes of the tube system and the anatomically modeled components, particularly the at least one artificial blood vessel, after the measurement. In further embodiments, the at least one pump serves the function of filling the tubes of the tube system and the anatomically modeled components, particularly the at least one artificial blood vessel, before commencement of the measurement. In further embodiments, the at least one pump is used to simulate the blood flow and the pulse in the system according to the invention, especially in the anatomically modeled components.

In embodiments, the change in the voltage, the current, or the frequency supply of the at least one pump results in a change in the delivery rate or pressure of the fluid in the fluid circuit and the anatomically modeled components. Depending on the type of pump, an increase or a decrease in the voltage, the current, or the frequency causes a change in the speed of the pump. In the following, this must therefore be differentiated depending on the type of pump. In embodiments, a change in the speed of the at least one pump leads to a change in the delivery rate or pressure of the fluid in the fluid circuit and the anatomically modeled components. The flow rate corresponds to the volume flow and hence to the blood flow of the fluid transported through the fluid circuit and the anatomically modeled components. The pressure of the fluid, which can be adjusted up or down, corresponds in turn to the simulated pulse, whereby a pulse curve or blood pressure curve can be generated. The change in current, voltage, or frequency and the associated change in speed of the at least one pump advantageously regulates and controls the amount of fluid conveyed and the intensity of the pressure of the fluid.

In a preferred embodiment, the at least one pump of the pump unit is embodied as a spiral pump, centrifugal pump, diaphragm pump, roller pump, shaking pump, water pump, or chain pump. In a further embodiment, with more than one pump, the pumps are independently selected from among a spiral pump, centrifugal pump, diaphragm pump, roller pump, shaking pump, water pump, or chain pump. The at least one pump is not limited to these types of pumps.

In embodiments, the at least one pump unit comprises at least two pumps, preferably two pumps. In one embodiment, a first pump of the at least two pumps is embodied as a pump such as a diaphragm pump, for example, for ventilating and/or venting the fluid circuit after and/or before the measurement. In one embodiment, the first pump is designed to convey fluids and gases. In particular, the tubes of the tube system and the at least one artificial blood vessel are ventilated and/or vented. The gas for this is preferably air, but it can also be inert. After each ventilation and/or venting, the fluid circuit is sealed in a gas-tight manner. This first pump then uses this first pump to fill the fluid circuit, particularly the tubes of the tube system, and the anatomically modeled components, particularly the at least one artificial blood vessel, with fluid from the fluid reservoir. The first pump is designed to be powerful. The second pump of the at least two pumps is embodied, for example, as a centrifugal pump or roller pump and is used to convey the fluid in the fluid circuit and the anatomically modeled components and to simulate the blood flow and the pulse in these components. In an alternative embodiment, the second pump is designed to convey fluids and gases.

In a further preferred embodiment, the at least one pump unit comprises at least three pumps. In one embodiment, a first pump of the at least three pumps is embodied as a pump such as a diaphragm pump, for example, for ventilating and/or venting the fluid circuit after and/or before the measurement. After each ventilation and/or venting, the fluid circuit is sealed in a gas-tight manner. This first pump then uses this first pump to fill the fluid circuit, particularly the tubes of the tube system, and the anatomically modeled components, particularly the at least one artificial blood vessel, with fluid from the fluid reservoir. The first pump is designed to be powerful. The second and third pumps of the at least three pumps are embodied, for example, as centrifugal pumps and/or roller pumps and are used to convey the fluid in the fluid circuit and the anatomically modeled components as well as to simulate the blood flow and the pulse in these components. In an alternative embodiment, the second pump is used to continuously convey the fluid and the third pump is used for simulation. The reactions are advantageously carried out independently of one another and are less prone to malfunctions. Furthermore, three pumps advantageously enable a more precise or more precise coordination, measurement, and configuration of the simulated blood flows. In a further alternative embodiment, the first pump is used to fill the fluid circuit and the anatomically modeled components with fluid, the second pump is used to continuously convey the fluid, and the third pump is used for simulation. In one embodiment, in the case of at least three pumps, at least the first, second, or third pump is designed to convey fluids and gases.

In one embodiment, the pumps are connected in series or connected to one another by connecting pieces, e.g., T-pieces.

In an alternative embodiment, in the case of a plurality of pumps involved in the simulation processes, these pumps can also come from different pump units.

In further embodiments, error monitoring takes place directly in the at least one pump. The monitoring also includes errors in the computer program product and process errors—for example if no calibration has taken place or the ventilation and/or venting of the system has failed.

In one embodiment, the at least one pump is also embodied as a sensor in addition to conveying fluids and gases. In that case, the at least one pump would be designed to read its current, voltage, frequency, and/or speed itself. In this way, direct inferences could be advantageously made about the events that have occurred in the system according to the invention, for example in the event of a drop in pressure.

The at least one pump unit preferably comprises at least one control unit.

In one embodiment, the control unit receives electrical signals from the at least one detection device.

In embodiments, the control unit is used to control and regulate the delivery rate or the pressure of the fluid in the fluid circuit. The blood circulation is thus advantageously simulated by the control unit. In a further embodiment, the control unit first receives electrical signals from at least one detection device and/or the sensors and transmits these as feedback electrical signals through signal transmission means to the electronic control, measurement, and evaluation unit. The electronic control, measurement, and evaluation unit, in turn, transmits a scenario-dependent control signal to the control unit.

In a preferred embodiment, the control unit of the pump unit sends a feedback control signal to the electronic control, measurement, and evaluation unit. The control unit transmits the received data from the detection device and/or the sensors through its connection implemented by means of signal transmission as electrical signals to the electronic control, measurement, and evaluation unit, while the electronic control, measurement, and evaluation unit, in turn, controls and regulates the control unit of the pump unit and thus advantageously monitors the delivery rate or the pressure of the fluid in the fluid circuit and hence also the simulated blood flow and pulse in the training model. By virtue of the fact that the electronic control, measurement, and evaluation unit transmits a scenario-dependent control signal to the control unit, the control unit advantageously reacts flexibly and in real time to the respective scenario.

In a preferred embodiment, the feedback electrical signal is used to vary, monitor, and analyze the training progress as well as the pulse curve and the delivery rate in the fluid circuit in real time.

According to the invention, the tube system comprises at least two first tubes. The tube system preferably comprises two first tubes.

The first tubes are preferably arranged between the patient model, particularly the at least one artificial blood vessel of the interchangeable practice region, and the pump unit. According to the invention, one end of each of the at least two first tubes is detachably connected to the end of each of the at least one artificial blood vessel, and the other end of each of the at least two first tubes is detachably connected to the at least one pump of the pump unit. In embodiments, the detachable connection of the tubes to the at least one pump, the fluid reservoir, and the anatomically modeled components is realized by tube connections or tube couplings.

In embodiments, the first end of the first feed is connected to the first end of the anatomically modeled component. In further embodiments, the second end of the first feed is connected to the at least one pump. In embodiments, the first end of the first return is connected to the second end of the anatomically modeled component. In further embodiments, the second end of the first return is connected to the at least one pump.

In the context of the invention, the at least two first tubes serve as the first feed and first return. The first feed of the first tube serves to convey the fluid in the fluid circuit in the direction of flow from the pump unit to the training model, particularly to at least one artificial blood vessel of the interchangeable practice region. The first return of the first tube is used to convey the fluid in the fluid circuit in the direction of flow from the training model, particularly from the at least one artificial blood vessel of the interchangeable practice region, to the pump unit.

In embodiments, the first tube embodied as the first feed corresponds to an arterial access, and the first tube embodied as the first return corresponds to a venous access.

In embodiments, the tubes are made of plastic tubes, advantageously of common medical plastic materials. In alternative embodiments, the tubes of the tube system have the same properties as the at least one artificial blood vessel.

In a preferred embodiment, the fluid circuit is embodied as a closed or an open fluid circuit.

In the case of a closed fluid circuit, the fluid conveyed by the at least one pump of the pump unit circulates through a closed tube system. The fluid is guided in a controlled and directed manner into and through the at least one artificial blood vessel. In the closed fluid circuit, the at least one pump causes a regularly recurring movement of the fluid within the fluid circuit. In one embodiment, the fluid is conveyed from the fluid reservoir by the at least one pump of the pump unit through the first feed of the tube system into one end of the at least one artificial blood vessel of the interchangeable practice region of the training model. After the fluid has been conveyed through the at least one artificial blood vessel, it circulates back into the fluid reservoir through the first return of the tube system. This process can be repeated as often as required. The fluid in the closed fluid circuit is thus permanently supplied to the fluid circuit.

In the case of an open fluid circuit, there is no regularly recurring movement of the fluid and thus no circulation of the fluid in the fluid circuit. The open fluid circuit therefore corresponds to a non-circulating fluid circuit. In the case of an open fluid circuit, the tube system and/or the anatomically modeled component such as the at least one artificial blood vessel has at least one separation device such as a valve.

In embodiments, the tubing of the tubing system and the anatomically modeled components, particularly the at least one artificial blood vessel, are filled by the at least one pump prior to commencement of the measurement, analogously to the filling of the closed fluid circuit. In an alternative embodiment, the first return of the tube system is not connected to the fluid reservoir, so that the fluid emerges from the first return and flows into the collecting tray. In both cases, the at least one separation device is open for this purpose. As a result, the gas can advantageously escape from the system, for example into the fluid reservoir or into the environment, until the tubes and the anatomically modeled component are completely filled with fluid. In the case of the open fluid circuit, after the tubes and the at least one artificial blood vessel have been filled, the connection between the first feed and the first return to the fluid reservoir is then closed. The closure is achieved by means of at least one separation device.

This closure advantageously results in an especially realistic increase and/or decrease in the fluid pressure in the tubes of the open fluid circuit, particularly in the first feed and in the first return, as well as in the at least one artificial blood vessel, and thus in a simulation of the pulse. In particular, a pulsating blood vessel can be simulated through the open fluid circuit.

In an alternative embodiment, the tubes of the tube system and the anatomically modeled components, particularly of the at least one artificial blood vessel, can only be ventilated and filled with gas by the at least one pump before commencement of the measurement, so that a pulse can also be simulated in the subsequent measurement.

However, if the at least one artificial blood vessel or the risk structure is damaged or injured in the open fluid circuit, the same mechanisms take effect as in the closed fluid circuit, in that fluid emerges from the opening formed and the at least one pump is controlled accordingly by the control unit of the pump unit.

In an alternative embodiment of the open circuit, at least one tube from the tube system has an opening at the end through which the fluid passes to the outside, i.e., into the surroundings and hence no longer back into the open fluid circuit. There is thus continuous simulated blood loss of the patient that is stopped only by eliminating the opening. The stressful situation of the user in the event of the patient bleeding out can thereby be advantageously practiced in a realistic manner.

According to the invention, the system has at least one detection device for monitoring the interventions in the interchangeable practice region. According to the invention, the at least one detection device is arranged in or on the anatomically modeled components of the interchangeable practice region.

In a preferred embodiment, the at least one detection device is arranged in or on the anatomically modeled component of the interchangeable practice region, which is embodied as at least one artificial blood vessel and/or anatomically modeled nerve tissue and/or anatomically modeled skin covering. The at least one detection device is thus arranged on the risk structures. If the risk structure is touched or injured, the detection device arranged thereon is also touched or injured at the same time. In alternative embodiments, the detection device is arranged on the anatomical replica of the body part and/or in the interchangeable practice region of the training model.

In a preferred embodiment, the at least one detection device is embodied as an electrically conductive structure and/or as a light-guiding structure. If the specifications listed below relate to both the electrically conductive structure and the light-guiding structure, only the term “structure” is used below. The structures have input channels through which the interactions with the user are recorded and passed on as electrical signals to the signal transmission means connected to the input channels.

In embodiments, the structure is at least partially disposed in areas of the interchangeable practice region. In preferred embodiments, the structure is arranged on the inner surface of the at least one artificial blood vessel and/or in or on the anatomically modeled nerve tissue and/or in or on the anatomically modeled skin covering.

In one embodiment, the structure is embodied as a lattice or mesh.

In embodiments, each structure is connected to a separate input channel, so that it can be determined and precisely tracked which risk structure has been touched or damaged and how. What is more, the degree of contact or damage or injury—i.e., the depth of contact or damage or injury—can be determined and displayed. The structure also serves to record certain items using the operative instruments.

In one embodiment, the structure is produced by casting processes, spraying processes, manual introduction of structures, or other processes. In further embodiments, the structures are used to determine the penetration depth of the surgical instruments and/or the implants, which advantageously enables depth detection. This advantageously simulates a blood withdrawal or an injection using cannulas or syringes.

In embodiments, the type and configuration of the structure can be selected individually depending on the application.

In one embodiment, the electrically conductive structures are used for larger diameters of the at least one artificial blood vessel or flat areas of the interchangeable practice region, whereas smaller diameters of the at least one artificial blood vessel are used for the light-guiding structures.

In embodiments, the electrically conductive structure has electrically conductive materials such as metals, alloys, sheet metal, wires, foils, plastics or plastic tubes, which contain electrolytic fluids.

In one embodiment, the electrically conductive structures are embodied as an electrical circuit. In further embodiments, at least the tips of the operative instruments and/or the tips of the implants or the operative instruments and/or the implants per se act as switches of the electrical circuit, whereby the electrical circuit is closed through touching or damaging of the electrically conductive structure by the tips of the operative instruments and/or the tips of the implants or by the operative instruments and/or by the implants per se, and an electrical signal is transmitted to the control unit of the pump unit depending on the determined electrical resistance.

In embodiments, the light-guiding structure has photoconductive materials such as fiber-optic cables made of PMMA or glass fiber cables. In one embodiment, diodes or illuminants are used as a source for coupling the light into the light-guiding structure and are connected to the light-guiding structure.

In embodiments, the light-conductive structures are embodied such that the illuminance of the light-conductive structures changes when they are touched or damaged. In embodiments, the light-conductive structures are embodied as light sensors that convert light into a voltage, current, or frequency and hence an electrical signal. At least one light sensor, selected from among a photodiode, a solar cell, a phototransistor, a photoresistor, or an integrated photosensor, detects the illuminance. The illuminance is advantageously dependent on the penetration depth of at least the tip of the surgical instrument and/or the tip of the implant or on the penetration depth of the surgical instruments and/or the implants per se and thus enables inferences to be made about the type and intensity of the contact or damage to the risk structure.

In a preferred embodiment, the system according to the invention comprises at least one operative instrument. In preferred embodiments, the operative instrument that is provided comprises various tools from the surgical and minimally surgical field, such as pointing tools, drills, ball plugs, surgical scissors, surgical forceps, suction devices, or medical endoscopes, for example. In the context of the invention, however, surgical instruments also include non-surgical instruments such as cannulas for cannulation.

The surgical instruments are advantageously positioned precisely at the desired and medically required location by the user.

At least the tips of the operative instruments or the operative instruments per se are designed to touch, damage, or injure the risk structures. The tip is understood to mean that portion of the operative instruments that is first positioned in terms of location and time on the front side of the interchangeable practice region.

In embodiments, the tips of the operative instruments or the operative instruments per se are designed to be at least partially electrically conductive and/or photoconductive. Consequently, these advantageously serve as switches for the electrical circuit in order to close it when the tips of the operative instruments or the operative instruments per se touch the electrically conductive structure of the detection device.

In one embodiment, the selected and medically required surgical instrument or instruments are positioned on the front side of the interchangeable practice region and guided through them to the rear side of the interchangeable practice region. The passage and positioning of the surgical instruments on the interchangeable practice region is visible as a puncture point in the anatomically modeled skin covering.

In embodiments, the operative instruments contain a marking which contains characteristic features and parameters. The marking is advantageously varied so that the operative instruments can be distinguished. The marking on the operative instruments is recorded by a detection means such as a camera and passed on to the computer program product, whereby it is recognized which operative instruments are being used in the respective training. In embodiments, the detection means also monitors the surgical procedure on the front side of the interchangeable practice region.

In one embodiment, the operative instruments have a tracker that is connected to the electronic control, measurement, and evaluation unit through signal transmission. The tracker advantageously enables precise localization of the operative instruments involved in the training so that the user can assess exactly where he or she is in the training model.

In further embodiments, any commercially available surgical instrument is suitable for training in invasive interventions using the system according to the invention. The commercially available surgical instruments can be provided with a marking. In embodiments, the operative instruments are embodied as attachments.

In one embodiment, the operative instruments are individually adapted to the training to be performed and can be advantageously interchanged depending on the type of training or in case of repairs.

In embodiments, the system according to the invention comprises at least one implant. In embodiments, the at least one implant comprises a medical implant such as a cochlear implant.

The implants are advantageously positioned precisely at the desired and medically required location by the user.

In one embodiment, the selected and medically required implants are positioned on the front side of the interchangeable practice region and guided through the interchangeable practice region to the rear side of the interchangeable practice region. The penetration and positioning of the implants at the interchangeable training region is visible as a puncture point in the skin covering.

The implants are individually adapted to the training to be carried out and can be advantageously interchanged depending on the type of training or in case of repairs.

In a preferred embodiment, the system according to the invention comprises at least one first sensor and/or at least one second sensor. To the extent that the corresponding specifications relate to the first and second sensors, these are referred to below simply as “sensors.”

In a preferred embodiment, the system according to the invention comprises at least one first sensor. In an alternative embodiment, the system according to the invention comprises at least two first sensors that are spaced apart from one another, with at least one first sensor serving as a reference sensor.

In embodiments, the at least one first sensor registers and measures changes in the delivery rate or the pressure, such as a drop in pressure, for example, in the fluid being conveyed through the fluid circuit.

In a preferred embodiment, the at least one first sensor is independently selected from among a flow sensor, a pressure sensor, or a volume sensor:

In embodiments, the at least one first sensor is arranged in or on the interchangeable practice region. In a preferred embodiment, the at least one first sensor is arranged in or on the at least one artificial blood vessel and/or the tube system. The at least one first sensor is very preferably arranged in the first feed or in the first return of the tube system, very especially preferably in the first return. In an alternative embodiment, the at least one first sensor is arranged in the opening of the anatomical replica of the body part or in the interchangeable practice region. In further alternative embodiments, the at least one first sensor is arranged in or on the anatomical replica of the body part.

In a preferred embodiment, the system according to the invention comprises at least one second sensor. In an alternative embodiment, the system according to the invention comprises at least two second sensors that are spaced apart from one another, with at least one second sensor serving as a reference sensor.

In embodiments, the at least one second sensor registers and measures changes in the fill level of the fluid in the fluid reservoir.

In a preferred embodiment, the at least one second sensor is embodied as a fill level sensor.

In a preferred embodiment, the at least one second sensor is arranged in or on the fluid reservoir.

In a preferred embodiment, the at least one first sensor and/or the at least one second sensor is connected to the control unit of the pump unit via signal transmission means. In one embodiment, the control unit receives electrical signals from the sensors.

The changes registered and measured by the sensors are transmitted as electrical signals. In alternative embodiments, the at least one first sensor and/or the at least one second sensor is connected to the electronic control, measurement, and evaluation unit via signal transmission means.

In a preferred embodiment, the at least one first sensor and/or the at least one second sensor measures the change in the delivery rate or the pressure of the fluid and/or the amount of the emerging fluid when the at least one artificial blood vessel is damaged. The at least one first sensor measures the change in the delivery rate or the pressure of the fluid and the at least one second sensor measures the amount of the emerging fluid.

In a preferred embodiment of the method according to the invention, the amount of fluid emerging from the at least one artificial blood vessel is measured by the at least one first sensor and/or the at least one second sensor and transmitted as an electrical signal via signal transmission means as a feedback electrical signal to the electronic control, measurement, and evaluation unit, whereupon the electronic control, measurement, and evaluation unit analyzes the data and, on that basis, transmits a scenario-dependent control signal via the signal transmission means to the control unit of the pump unit, whereby an autonomous reaction and control of the at least one pump unit is carried out through an increase or a decrease in the voltage, the current, or the frequency of the at least one pump.

In a further preferred embodiment of the method according to the invention, the amount of fluid emerging from the at least one artificial blood vessel is measured by the at least one first sensor and/or the at least one second sensor and transmitted as an electrical signal via signal transmission means to the control unit of the pump unit. The control unit then transmits the data as feedback electrical signals through signal transmission means to the electronic control, measurement, and evaluation unit. The electronic control, measurement, and evaluation unit, in turn, continues to analyze the data and transmit the scenario-dependent control signal to the control unit.

In embodiments, the system according to the invention realizes a simulation of bodily functions—referred to as parameters—such as the pulse rate and/or the blood pressure and/or vital functions. The corresponding vital values can be derived from the pulse rate and/or the blood pressure. This is implemented by the control unit of the pump unit, which, in turn, receives and evaluates signals from the detection device and/or the sensors and receives and evaluates signals from electronic control, measurement, and evaluation units.

In embodiments, a mean blood pressure in the range from 50 mmHg to 250 mmHg can be simulated. In further embodiments, a pulse amplitude in the range from 0% to 150% versus the normal value can be simulated. In further embodiments, a pulse beat can be simulated by a volume flow in the range from 20 ml/min to 400 ml/min.

In a further embodiment, a variation or manipulation of the bodily functions is implemented by the system according to the invention. This also includes a variable bleeding intensity, for example. In further embodiments, the simulated bodily functions are individually adapted to the respective training session.

When the anatomically modeled components of the interchangeable training region are touched, at least the tips of the surgical instruments and/or the tips of the implants or the surgical instruments and/or the implants per se touch the anatomically modeled components of the interchangeable training region and establish physical contact. Through this contact, operative events such as contact or injuries are determined—e.g., the reaching of certain positions in the interchangeable practice region by the operative instruments. These positions are reached by navigation, through which the user of the system according to the invention learns to localize predetermined anatomical locations, for example in the course of his or her training.

In the event of damage or injury to the anatomically modeled components of the interchangeable practice region, at least the tips of the surgical instruments and/or the tips of the implants or the surgical instruments and/or the implants per se pierce or cut through the anatomically modeled components of the interchangeable practice region and establish physical contact. In one embodiment, damage or injury to the anatomically modeled components of the interchangeable practice region is reversible, meaning that the correspondingly damaged or injured anatomically modeled components can be repaired later or heal themselves again, for example through the resilience of the materials of the artificial blood vessels and/or the nerve tissue and/or the skin covering. In alternative embodiments, damage or injury to the anatomically modeled components of the interchangeable practice region is irreversible, meaning that the correspondingly damaged or injured anatomically modeled components can no longer be repaired at a later time.

It is irrelevant here whether the at least one artificial blood vessel, the anatomically modeled nerve tissue, and/or the anatomically modeled skin covering alone or in combination were touched or damaged or injured.

According to the invention, the system is designed in such a way that the detection device detects an interaction of the user with the anatomically modeled components of the interchangeable practice region. The system according to the invention is also designed in such a way that the data generated by the interaction are then transmitted as electrical signals via the signal transmission means as feedback electrical signals to the electronic control, measurement, and evaluation unit, whereupon the electronic control, measurement, and evaluation unit analyzes the data and, on that basis, transmits a scenario-dependent control signal via the signal transmission means to the control unit of the pump unit, whereby an autonomous reaction and control of the at least one pump unit is carried out by increasing or decreasing the voltage, the current, or the frequency of the at least one pump.

In a further preferred embodiment, the system according to the invention is embodied such that the data generated by the interaction are transmitted as electrical signals via the signal transmission means to the control unit of the pump unit. The control unit then transmits the data as feedback electrical signals through signal transmission means to the electronic control, measurement, and evaluation unit. The electronic control, measurement, and evaluation unit, in turn, continues to analyze the data and transmit the scenario-dependent control signal to the control unit.

In this way, the blood flow is advantageously adapted individually to the respective scenario by the at least one pump by changing the delivery rate and the blood pressure and pulse by changing the intensity of the pressure of the fluid.

In embodiments, the scenarios are established prior to training. The corresponding bodily functions are adjusted through the previously defined scenarios. This is carried out by the measurement, control, and evaluation unit.

An interaction of the user with the system is understood in terms of the invention to mean at least partial contact with or damage or injury to the anatomically modeled components of the interchangeable practice region and hence also with the risk structures. Touching also includes reaching certain risk structures, positions, or structures of the training model by means of the operative instruments.

In embodiments, contact with or damage or injury to the anatomically modeled components, and hence the risk structures, is detected by the electrically conductive and/or light-guiding structures of the detection device. The detected contact or damage or injury to the anatomically modeled components is transmitted by the detection device as an electrical signal and scenario-dependent control information through signal transmission means to the control unit of the pump unit coupled to the detection device.

In embodiments, changes in the delivery rate or the pressure of the fluid are recorded and measured by at least one first sensor due to the damage or injury to the anatomically modeled components. In a further embodiment, changes in the level of the fluid in the fluid reservoir are registered and measured by at least one second sensor as a result of the damaging or injuring of the anatomically modeled components. These changes that are registered and measured by the sensors are transmitted as electrical signals via signal transmission means to the control unit of the pump unit that is coupled to the sensors.

In embodiments, in the event of damage to the at least one artificial blood vessel, fluid emerges from the damaged area of the artificial blood vessel that is embodied as an opening. The sensors measure the amount of fluid emerging from the at least one artificial blood vessel. The at least one first sensor determines the amount of emerging fluid based on the change in the delivery rate or pressure of the fluid in the at least one artificial blood vessel and/or the tube system, and/or the at least one second sensor determines the amount of emerging fluid based on the level in the fluid reservoir. These data are also transmitted as electrical signals via the signal transmission means to the control unit of the pump unit.

Due to the emergence of fluid from the opening that is embodied as a damaged area, the fluid is not added back to the open or closed fluid circuit, whereby the fluid in the fluid circuit is lost and fluid still present in the fluid reservoir is used up. Blood loss on the part of the patient is thus simulated and can be variably configured. The user has to close the opening again before the volume of the fluid in the fluid circuit has fallen below a critical level. In the context of the invention, a critical level is understood to mean a volume of fluid that is reached in a real case and has a fatal outcome if a blood substitute is not supplied from outside. In one embodiment, the critical level of the fluid corresponds to a volume of less than 3 l.

The mechanisms and subsequent reaction of the pumps when the fluid emerges from the opening in the event of damage or injury are the same for the closed and open fluid circuit.

In embodiments, the control unit of the pump unit controls and causes an increase or a decrease in the voltage, the current, or the frequency of the at least one pump of the pump unit when the anatomically modeled components of the interchangeable practice region are touched or damaged or injured. The increase or decrease in the voltage, the current, or the frequency and the associated change in speed as a result of an increase or a decrease in the delivery rate and pressure of the fluid in the fluid circuit realistically simulates an increased or a decreased pulse rate and/or an increased or a decreased blood pressure. This is done either as a general mode of operation of the system according to the invention in order to enable individual training adapted to the respective physiology of the patient or as a hazard warning for the user in the event of touching or damage or injury to the anatomically modeled components of the exchangeable exercise region and hence the risk structures. The at least one pump of the pump unit is preferably operated in a pulsed manner. For this purpose, the supply current, the voltage or the frequency of the at least one pump is variably increased and/or decreased depending on the application.

In one embodiment, especially if the anatomical replica of nerve tissue has been injured, the increase or decrease in the voltage, the current, or the frequency of the at least one pump and the associated change in speed in the form of an increase or a decrease in the delivery rate and pressure of the fluid realistically simulates an increased or a decreased adrenaline output of the patient in the fluid circulation.

In embodiments, the formation of aneurysms and/or hematomas is simulated when the anatomically modeled components of the interchangeable practice region, and hence also the risk structures, are touched or damaged or injured.

Another aspect of the invention relates to a method for validation and training in invasive interventions in human and veterinary medicine by means of the system according to the invention. According to the invention, the detection device detects an interaction of the user with the anatomically modeled components of the interchangeable practice region. Subsequently, the data generated by the interaction are then transmitted as electrical signals via the signal transmission means as feedback electrical signals to the at least one electronic control, measurement, and evaluation unit, whereupon the at least one electronic control, measurement, and evaluation unit analyzes the data and, on that basis, a scenario-dependent control signal is transmitted via the signal transmission means to the control unit of the pump unit, whereby an autonomous reaction and control of the at least one pump unit is carried out by increasing or decreasing the voltage, the current, or the frequency of the at least one pump.

In a preferred embodiment, the detection device detects an interaction of the user with the anatomically modeled components of the interchangeable practice region, whereupon the data generated by the interaction are transmitted as electrical signals via the signal transmission means to the control unit of the pump unit, and the control unit transmits the data as feedback electrical signals via signal transmission means to the electronic control, measurement, and evaluation unit. The electronic control, measurement, and evaluation unit, in turn, continues to analyze the data and transmit the scenario-dependent control signal to the control unit.

In embodiments, before the training begins, all components of the system according to the invention are connected, whereby an automatic system initiation takes place. Within this process, the fluid circuit, particularly all of the tubes of the tube system and the at least one artificial blood vessel, is vented before fluid is fed into the fluid circuit. This is done because, otherwise, the automatic control of the system would be corrupted, since residual gas such as air would distort the measurement due to its compressibility. After venting, the fluid circuit is sealed in a gas-tight manner.

In embodiments, the system is then automatically calibrated. In this way, the necessary control parameters are advantageously set as a function of the tube length, diameter, and shape of the tubes of the tube system and of the at least one artificial blood vessel in order to obtain the desired scenario-dependent pulse curves.

In one embodiment, a scenario-dependent adaptation of the pulse curve is performed after the automatic calibration. Advantageously, this enables realistic OP situations and interventions to be simulated on the training model.

In embodiments, the fluid circuit, particularly the tube system and/or the at least one artificial blood vessel, is ventilated with gas at the end of the training. In this case, a gas such as air, for example, is pumped by at least one pump that is designed to convey fluids and gases through the entire fluid circuit and the at least one artificial blood vessel. This advantageously prevents the undesired escape of fluid when replacing components such as the interchangeable practice region or generally when dismantling the system according to the invention.

According to the invention, the system comprises at least one electronic control, measurement, and evaluation unit.

By virtue of the fact that the electronic control, measurement, and evaluation unit transmits a scenario-dependent control signal to the control unit, the control unit can advantageously react flexibly and in real time to the respective scenario.

In embodiments, the electronic control, measurement, and evaluation unit is a computer.

In a preferred embodiment, a computer program product is stored on the electronic control, measurement, and evaluation unit.

In a preferred embodiment, a computer program product is used to carry out the method according to the invention. The computer program product ensures a virtual and/or realistic representation of the operating field and the course of the training. Furthermore, the computer program product enables the graphic representation of the parameters of the bodily functions that were selected depending on the scenario before the training and were measured during the training. The electrical and/or optical signals from the input channels of the structures of the detection device and/or the control unit of the pump unit are also transmitted to the computer program product via signal transmission means. The electronic control, measurement, and evaluation unit and the computer program product stored thereon ensure a virtual and/or realistic representation of the examination as well as automated control and monitoring of the operating field during training on the training model, i.e., during operation of the system. The electronic control, measurement, and evaluation unit thus acts as an OP assistance system during training on the system according to the invention. In one embodiment, the computer program product stored on the electronic control, measurement, and evaluation unit selects an algorithm based on the interaction determined by the detection device and/or the sensors and transmitted electrical signals that are transmitted as a scenario-dependent control signal to the control unit of the pump unit. This algorithm regulates and controls the voltage, the current, the frequency, and the associated speed of the at least one pump and thus influences the training scenario in real time.

In embodiments, the interchangeable training region corresponds to the operating field for the user of the training model in which he or she practices operative and invasive interventions. In alternative embodiments, the anatomical replica of the body part or the anatomical replica of the body part and the interchangeable practice region correspond to the operating field for the user of the training model in which he or she practices operative and invasive interventions. With regard to the operating field, reference will be made in the following only to the interchangeable practice region, but this can also refer to the anatomical replica of the body part or the anatomical replica of the body part and the interchangeable practice region.

A virtual representation is understood to mean a three-dimensional reproduction of the training progress in the operating field of the interchangeable practice region that is generated by a computer program product. Medical image material stored on a storage medium serves as the basis for the virtual representation that is generated by a computer program product. During the training, the position and the movement of the operative instruments in the three-dimensionally displayed training model are reproduced in the correct position by the computer program product. In particular, the interchangeable practice region and the anatomically modeled components are shown three-dimensionally and realistically. In embodiments, the interchangeable practice region, particularly the anatomically modeled components, as well as the risk structures, are represented at least partially transparently by the computer program product. This advantageously relates particularly to the skin covering and/or the fatty tissue and/or the muscles, whereby the actual training can be advantageously monitored on the risk structures.

In one embodiment, the data generated by the interaction that have been transmitted to the electronic control, measurement, and evaluation unit are used to visualize further information for the user. In addition to a pulse curve or a blood pressure curve, the computer program product contained in the electronic control, measurement, and evaluation unit can also be used to visualize vital signs for the user from the simulated pulse.

A realistic representation is understood to mean a visual reproduction of the training progress in the operating field of the interchangeable practice region that is transmitted via an optoelectronic detection means, for example, as a video image in real time.

The virtual and/or realistic representation of the operating field is transmitted to the electronic control, measurement, and evaluation unit via the signal transmission means while the user is acting simultaneously with the training model, particularly the interchangeable practice region.

In embodiments, the system according to the invention comprises signal transmission means. In one embodiment, the signal transmission means is instantiated by electrical cables. In further embodiments, the signal transmission means is a wireless connection in the form of Bluetooth or WLAN, for example.

In a further embodiment, the signal transmission means is a combination of electrical cables and a wireless connection.

According to the invention, the at least one detection device is connected to the electronic control, measurement, and evaluation unit through signal transmission. In a further preferred embodiment, the at least one detection device is connected to the control unit of the pump unit via signal transmission means.

The electronic control, measurement, and evaluation unit is preferably connected to the control device of the pump unit through signal transmission. Through the signal transmission means, the data ascertained by the detection device that have been transmitted in electrical signals to the control unit are transmitted from the control unit to the electronic control, measurement, and evaluation unit. The electronic control, measurement, and evaluation unit, in turn, analyzes this information, and the computer program product stored thereon selects an algorithm for the mode of operation of the at least one pump on that basis. This algorithm determines, for example, the change in current, voltage or frequency and the associated change in speed of the at least one pump and thus defines the training scenario and influences it in real time. The associated control signals, in turn, are transmitted from the electronic control, measurement, and evaluation unit to the control unit of the pump unit, which then controls the at least one pump. Depending on the training on the training model, the detection device and/or the sensors will register a further change, so that the control and monitoring by the feedback electrical signal that is exchanged continuously between the detection device and/or the sensors or the control device of the pump unit and the electronic control, measurement, and evaluation unit via signal transmission means is adapted accordingly.

In embodiments, the operative instruments and/or the implants are connected to an electronic control, measurement, and evaluation unit of the system through signal transmission.

In one embodiment, the surgical scenarios to be learned can be studied on the basis of process flow protocols. In the process flow protocols, parameters are specified which provide information on the quality of the intervention being practiced and hence (with several tests) on learning success as a performance control. The parameters are the time of execution, economy of hand movement, and injury to functionally important anatomical areas, for example.

In embodiments, the operative instruments used during training and/or the implants used are recognized by the computer program product on the basis of the markings applied to them and are calibrated accordingly for the respective training situation. In this way, the training and the training progress at the training model are controlled and monitored.

In one embodiment, the surgical instruments and/or the implants are calibrated in order to determine the axis lengths and the location of the tip of the surgical instruments and/or of the implants. In addition, a directional calibration takes place in which the orientation of the surgical instruments and/or the implants within the virtual and/or realistic representation of the surgical field is determined.

In further embodiments, the appropriately used interchangeable practice region is recognized by the computer program product with the specific parameters for the configuration of the interchangeable practice region as well as patient-specific data contained on its respective storage medium.

In a further embodiment, a patient calibration is carried out in which the coordinate system generated in the virtual and/or realistic representation of the interchangeable practice region is aligned with the coordinate system of the surgical instruments and/or the implants.

In a preferred embodiment, the feedback signal from the optoelectronic detection means that is arranged in the interchangeable practice region of the training model is sent to the electronic control, measurement, and evaluation unit and evaluated and analyzed by the computer program product, so that training progress is monitored and assessed in real time. The training duration, navigation, and the number of injuries are also registered by the computer program product.

In embodiments, the anatomical replica of the body part and/or the interchangeable practice region can be produced by means of additive manufacturing processes on the basis of three-dimensional patient data. For example, the anatomical replica of the body part and/or the interchangeable practice region can be produced using a rapid prototyping method. In this way, a patient-specific anatomy of the anatomical replica of the body part or the interchangeable practice region can be advantageously represented, so that each training session can be designed and carried out individually.

In embodiments, the system according to the invention comprises a holding device. In embodiments, the anatomical replica of a body part and/or the anatomical replica of an interchangeable practice region is embodied so as to be insertable into a holding device. The anatomical replica of the body part and/or the anatomical replica of the interchangeable practice region has a front side, which is accessible from the outside, and a rear side, which is connected in a form-fitting manner to the holding device. In embodiments, the rear side of the anatomical replica of a body part and/or the interchangeable practice region is at least partially in physical contact with a holding device.

In one embodiment, the holding device is embodied as a technical holder. A technical holder is understood here to be a holder whose design is purely mechanical and functional and not anatomical. The anatomical replica of the body part and/or the anatomical replica of the interchangeable practice region can be advantageously inserted in a form-fitting manner into any conceivable holding device. The anatomical replica of the body part and/or the interchangeable practice region is advantageously stored in a stable manner by the holding device during exercise and is secured against slipping.

In embodiments, the holding device is also embodied as a collecting tray. In the event of an injury to the at least one artificial blood vessel, fluid that escapes is advantageously caught by the holding device and does not cause any soiling. In addition, the collected fluid can be reused.

In preferred embodiments, the anatomical replica of an interchangeable practice region, which is claimed for itself, is designed to be inserted into a holding device.

In a preferred embodiment, the training model of the system according to the invention comprises an optoelectronic detection means.

In embodiments, the optoelectronic detection means is arranged in the anatomical replica of the body part. In embodiments, the optoelectronic detection means is arranged in the opening of the anatomical replica of the body part such that it is designed to detect the surgical interventions and monitor the positioning of the surgical instruments and/or the implants on the rear side of the interchangeable practice region by means of the electronic control, measurement, and evaluation unit. In alternative embodiments, the optoelectronic detection means is arranged on the rear side of the interchangeable practice region.

In embodiments, the optoelectronic detection means is connected to the electronic control, measurement, and evaluation unit through signal transmission, whereby a feedback signal is advantageously sent from the optoelectronic detection means to the electronic control, measurement, and evaluation unit. The transmitted signal contains data about the current training progress. The data include audiovisual specifications such as image resolution and derived aspect ratio, frame rate, and color depth. By arranging the optoelectronic detection means in the training model, the operative interventions and techniques that take place during the training are advantageously transmitted to the electronic control, measurement, and evaluation unit via the signal transmission means. This ensures that the positioning of the surgical instruments and/or the implants on the interchangeable practice region is monitored.

In embodiments, the optoelectronic detection means is used to record the processes taking place within the training model and to inform the user in real time about training success and the positioning of the surgical instruments and/or of the implants. The operating field is thus controlled automatically. For example, successful training includes the positioning of the surgical instruments and/or of the implants—that is, how far a cochlear implant was able to be inserted into the anatomical replica of the body part and/or an interchangeable practice region.

The optoelectronic detection means also advantageously ensures performance control of the intervention on the training model, in that it can be estimated, for example, how far an operative instrument and/or an implant can be inserted. The vulnerable risk structures are advantageously monitored by the optoelectronic detection means.

During the intervention, the optoelectronic detection means advantageously enables inferences to be made about possible injured risk structures and hence injuries, whereby the success of the operation can be tracked. The performance control and the learning success give the user security and routine during the operative interventions. Furthermore, the progression of the operation is advantageously assessed. For example, an assessment is made of the type of positioning of the surgical instruments and/or of the implants or how much of the tissue to be removed or of the risk structures or of the anatomical space surrounding the risk structures has been removed.

In embodiments, the optoelectronic detection means is a recording device such as a digital video camera. In alternative embodiments, the optoelectronic detection means is a web cam. In embodiments, the optoelectronic detection means has a CMOS sensor. In alternative embodiments, the optoelectronic detection means has a CCD sensor, especially a two-dimensional CCD array sensor.

In embodiments, the feedback signal from the optoelectronic detection means is sent to the electronic control, measurement, and evaluation unit and evaluated and analyzed by the computer program product, so that the course of the training is monitored and assessed in real time. The training duration and the number of injuries are also registered by the computer program product. The training can be advantageously interrupted at an early stage if errors occur, thus enabling time to be saved or the training to be continued or restarted later.

Errors that occur are understood to mean, for example, incorrect positioning combined with incorrect passage of the surgical instruments and/or the implants in the interchangeable practice region. The number of injuries to functionally important anatomical areas that were caused by incorrect penetration or positioning of the surgical instruments and/or the implants is registered.

In embodiments, the optoelectronic detection means transmits the recorded data as electrical signals to the electronic control, measurement, and evaluation unit during operation, i.e., during training. In further embodiments, the optoelectronic detection means transmits the recorded data as electrical signals to the electronic control, measurement, and evaluation unit before or after the training.

In a preferred embodiment, the training model of the system according to the invention comprises a storage medium.

In embodiments, the interchangeable practice region comprises a storage medium. In further embodiments, the storage medium is arranged on the rear side of the interchangeable practice region.

The anatomical replica of the body part and/or the interchangeable practice region form a detachable plug connection with the storage medium. This ensures an electrical connection and a data connection, especially as a hardware interface.

The storage medium is also known as data storage. In embodiments, a semiconductor memory serves as the storage medium. In embodiments, the storage medium is a memory chip. In embodiments, the storage medium is embodied as a non-volatile data memory such as a flash memory, for example.

In one embodiment, data records are stored on the storage medium. In embodiments, patient-specific data are stored on the storage medium. The provided patient-specific data advantageously enable a training model to be provided which is specially adapted to the corresponding anatomies and disease histories and allows for effective and targeted use of the training model. The specific parameters for the configuration of the interchangeable practice region also provide information on the body region to be examined.

In embodiments, the patient-specific data stored on the storage medium include parameters relating to the patient's anatomy, the patient's age, previous findings, pathogenesis, the clinical picture, and existing evidence of imaging methods such as CT or X-ray images, which are used as templates, provide orientation, and make the training situation appear as realistic as possible. In one embodiment, the patient-specific data correspond to the medical record of the respective patient to be examined. Advantageously, the user can get an idea of the upcoming practice intervention and of the training that is to be carried out before the exercise. This makes the intervention to be practiced more realistic.

In further embodiments, specific parameters for the configuration of the interchangeable practice region and hence of the body region to be examined are stored on the storage medium. The body region to be examined is thus advantageously not only available as an interchangeable practice region but also includes all of the specific parameters that are required, such as configuration and geometry of the interchangeable practice region, in order to carry out the training.

In embodiments, the storage medium can be written on or overwritten with further patient-specific data. This is done by additionally writing and supplementing the data on the storage medium or by overwriting the originally existing patient-specific data. Further patient-specific data is understood to mean either extended findings from the same patient or further data from another patient with a different clinical picture and anatomy and age that are completely new or additionally written and stored on the storage medium. The user can therefore always practice new interventions on the training model. Furthermore, the control electronics of the storage medium can always be updated, which reduces errors in the form of manipulations or failures.

In embodiments, the storage medium is connected in a mechanically detachable manner to the interchangeable practice region. In one embodiment, the storage medium is releasably arranged in the interchangeable practice region. In further embodiments, the storage medium is releasably arranged in the rear side of the interchangeable practice region. The storage medium can thus be advantageously removed from the interchangeable practice region in order to have further or new patient-specific data to be written on it, in order to have additional or new specific parameters for the configuration of the interchangeable practice region to be written on it, or in order to update the control electronics and reconnected thereto.

The detachable arrangement of the storage medium in the interchangeable practice region makes it possible to connect different storage media—each of which contains different patient-specific data and specific parameters for the configuration of the interchangeable practice region—to the interchangeable practice region and thus to perform training in different clinical pictures for the identically configured interchangeable practice region.

In embodiments, the storage medium is connected in a mechanically and electrically releasable manner to the interchangeable practice region.

In embodiments, the storage medium is connected to the electronic control, measurement, and evaluation unit through signal transmission.

When the interchangeable practice region is connected to the storage medium, the storage medium with the patient-specific data provided thereon and the specific parameters for the configuration of the interchangeable practice region are recognized by the electronic control, measurement, and evaluation unit. This is done by transmitting the patient-specific data and the specific parameters for the configuration of the interchangeable practice region to the electronic control, measurement, and evaluation unit and assigning them thereto. This ensures data exchange upon connecting the storage medium with the interchangeable practice region to the electronic control, measurement, and evaluation unit.

Advantageously, the storage medium avoids time-consuming access to a complete database such as is described, for example, in DE 20 2012 011 452 U1 and which contains all patient-specific data and which, for example, first has to be loaded or transmitted. Quick and independent access to the patient-specific data and specific parameters of the anatomical replica of the body part and/or of the interchangeable practice region is advantageously ensured without a complete database having to be updated, for example.

The patient-specific data and specific parameters for the configuration of the anatomical replica of the body part and/or of the interchangeable practice region contained on the storage medium can be advantageously accessed quickly at any time. The system is not dependent on a central database that can be accessed via an internet connection, for example, which would necessitate the provision of a reliable connection at all times. The training model can thus also be used advantageously in locations without an internet connection. Furthermore, the patient-specific data and the specific parameters for the anatomical replication of the body part and/or the configuration of the interchangeable practice region are advantageously not affected in the event of a system crash, for example, since they are not stored centrally in a database but on a storage medium.

By transmitting and displaying the patient-specific data when connecting the interchangeable practice region to the storage medium, it is immediately recognized which patient (age, anatomy, previous findings, pathogenesis, clinical picture, existing evidence of imaging processes such as CT or X-ray images) is involved and which operative interventions the user has to undertake. By simultaneously transmitting and displaying the specific parameters about the respective configuration of the interchangeable practice region to be examined when connecting the anatomical replica of the body part to the interchangeable practice region, it is also immediately recognized which interchangeable practice region is involved.

In a preferred embodiment, the system according to the invention or the method according to the invention is used for validation and training in invasive interventions in human and veterinary medicine. The system is preferably used for vascular interventions.

In a further preferred embodiment, the computer program product is used for validation and training in invasive interventions in human and veterinary medicine.

In embodiments, the system is intended for students, specialists, trainees, or system testers for practicing. In embodiments, the system is intended for companies that deploy, use, and/or demonstrate handling of their own surgical instruments and/or of their own implants.

The operative interventions include surgical as well as minimally invasive surgical interventions.

The surgical interventions are carried out using the surgical instruments and/or the implants that are provided.

The surgical interventions to be practiced include, for example, the removal of bones, the insertion of medical implants, the setting of medical screws, the creation of accesses, the removal of tissue such as tumors, and the creation of surgical accesses to the diseased regions.

The surgical interventions to be practiced also include minimally invasive methods such as medical endoscopy, minimally invasive spinal surgery (including the decompression of spinal cord areas and fusion of vertebrae after herniated discs), the placement of implants, and the removal of tumors and/or bone adhesions.

The system according to the invention advantageously makes effective training possible for the user. The training can be monitored in real time by the optoelectronic detection means. By virtue of the customized anatomical configuration and the patient-specific data on the storage medium, the user is able to focus on an individual and special problem.

The training model advantageously comprises interchangeable components such as flushable, bone-like material and pneumatized bones.

The typical surgical procedures to be practiced in the temporal bone region include training in mastoidectomy and cochleostomy as well as the placement of implants, such as middle and inner ear implants.

The artificial paranasal sinus patients make training in skull base surgery possible, above all, as well as functional endoscopic sinus surgery (FESS), in which, among other things, the opening of the paranasal sinuses and the removal of tumors (pituitary tumor) or polyps are among the frequent interventions to be practiced. Dealing with an injury to a cerebral blood conductor during surgery can be simulated here.

In spinal surgery, training-intensive interventions are very common in operations on intervertebral discs during decompression or when fixing the vertebral bodies (after a fracture, for example). Furthermore, with the aid of the training model, minimally invasive surgical techniques and manual skills such as the placement of pedicle screws and intervertebral implants (cages) as well as the fusion of vertebrae can be learned.

In embodiments, the system according to the invention and the method according to the invention are used to simulate a blood transfusion. In further embodiments, the system according to the invention and the method according to the invention are used for training in dialysis. In this way, blood withdrawal and blood addition through the tube system and/or the at least one artificial blood vessel and the pump unit can be advantageously implemented and practiced.

In order to train in dialysis, the first feed and the first return are used to remove the blood for hemodialysis by means of cannulas and, after the hemodialysis has been completed, to feed it back to the training model. Advantageously, the anatomically modeled skin covering creates a realistic haptic feeling for the user.

In one embodiment, due to the resilience of the anatomically modeled components of the interchangeable practice region, the exercises, such as blood sampling or dialysis, for example, can be practiced several times without disposing of the components immediately after the first exercise. This advantageously saves costs and resources.

By using the training model, the quality and learning success of the surgical interventions are validated. This performance control immediately informs the user whether risk structures have been violated or whether the operation proceeded flawlessly.

The training advantageously takes place under real conditions, since the system reacts in real time to a possible violation of the risk structures.

In embodiments of the invention, the components of the training model are designed to be reusable.

Depending on the type of training carried out, all or some of the components of the training model can be reused. After training, the anatomical replica of the body part and/or the interchangeable training region is removed and the two components are cleaned separately. The anatomical replica of the body part and/or the interchangeable practice region is removed from the holding device, and the holding device for the anatomical replica of the body part is also cleaned. Furthermore, the surgical instruments and/or implants used are cleaned.

Due to the possibility of supplementing the trainer with a controllable blood pump, emergency management after a surgical error, such as the injuring of an artery, also becomes an object of training.

In implementing the invention, it is also expedient to combine the above-described embodiments according to the invention and features of the claims in appropriate configuration.

### EXEMPLARY EMBODIMENT

The invention will be explained in greater detail in the following with reference to an exemplary embodiment. The exemplary embodiment relates to an interchangeable practice region that is embodied as a forearm, and it is intended to describe the invention without restricting it.

The invention will be explained in further detail with reference to a drawing. In the drawing,

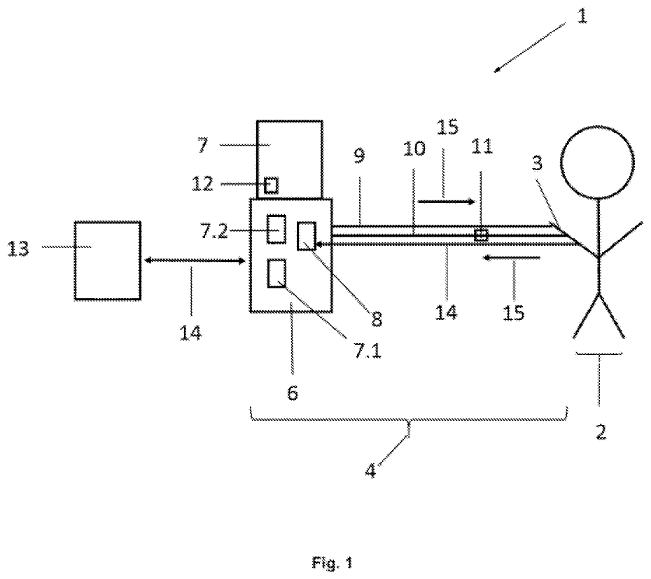

FIG. 1 shows a schematic representation of the method according to the invention.

FIG. 1 shows a schematic representation of the system 1 according to the invention. The sketch is not true to scale. The system 1 according to the invention has a training model 2, which is shown schematically as a stick figure. In this case, the interchangeable practice region of the training model 2 is a human forearm. The forearm comprises an anatomically modeled component 3 that is embodied as an artificial blood vessel and is not reproduced in detail in FIG. 1 but can only be attributed to the schematic arm of the stick figure. The system 1 according to the invention is operated at a system voltage of 12 V.

The system 1 according to the invention also has a fluid circuit 4 that has a fluid reservoir 5 in the form of a tank as a closed circuit, a pump unit 6, and a tube system. The fluid corresponds to imitation blood.

The pump unit 6 has a control unit 8 and two pumps 9, a first pump 7.1 being embodied as a self-priming water pump and a second pump being embodied as a centrifugal pump 7.2. The first pump 7.1 is used to vent the fluid circuit 4 before the measurement, whereby the tube system and the artificial blood vessel 3 are vented with air. Subsequently, the first pump 7.1 is used to fill the fluid circuit 4—particularly the tube system and the blood vessel 3—with fluid from the fluid reservoir 5. The second pump 7.2 ensures the conveyance of the fluid in the fluid circuit 4 and the artificial blood vessel 3 and simulates blood flow and pulse rate.

The first pump 7.1 is operated at a nominal voltage of 12 V and has a delivery rate of max. 2 l/min and a delivery head of max. 3 m. The pressure formed by the first pump 7.1 is a maximum of 2 bar. The first pump 7.1 enables a maximum delivery rate of 60 l/h in the fluid circuit 4 and the anatomically modeled component 3. The second pump 7.2 generates a mean blood pressure of 50 mmHg to 250 mmHg, a pulse amplitude of 0% to 150% of the normal value, and a flow rate of 400 l/min.

The tube system has a first feed 9 and a first return 10. The arrows indicate the direction of flow of the fluid 15. The first feed 9 and the first return 10 of the tube system connect the anatomically modeled component 3 to the pumps 9 of the pump unit 6. It should be noted here that the feed 9 and the return 10 are only shown schematically in FIG. 1, for example in that they each only run into the pump unit 6 without the exact connection being specifically reproduced. The first end of the first feed 9, which is embodied as a tube (to the right in the figure), is connected to the first end of the anatomically modeled component 3. The first end of the first return 10, which is embodied as a tube (to the right in the figure), is connected to the second end of the anatomically modeled component 3. The second end of the first feed 9 (to the left in the figure) is connected to the first pump 7.1 and the second pump 7.2. The second end of the first return 10 (to the left in the figure) is connected to the first pump 7.1 and the second pump 7.2 (the connections are not shown in the figure).

The fluid reservoir 5 is placed directly on the pump unit 6 and connected to the first pump 7.1 and the second pump 7.2 of the pump unit 6 via a respective quick-release coupling.

A first sensor 11, which is embodied as a flow sensor, is arranged in the first return 10 of the tube system. A second sensor 12, which is embodied as a fill level sensor, is arranged in the fluid reservoir 5. If the anatomically modeled component 3 is damaged or injured, the first sensor 11 measures the change in the delivery rate of the fluid that is being conveyed through the fluid circuit 4 and the anatomically modeled component 3. The second sensor 12 measures the amount of escaping fluid in the event of damage or injury to the anatomically modeled component 3. Both the first sensor 11 and the second sensor 12 are connected to the control unit 8 of the pump unit 6 via signal transmission means 14.

The interventions in the interchangeable practice region are monitored and recorded by a detection device (not shown in the figure) that is arranged on the anatomically modeled component 3. The contact or damage or injury to the anatomically modeled component 3 that is detected by the detection device is transmitted as an electrical signal and scenario-dependent control information through signal transmission 14 to the control unit 8 of the pump unit 6 that is coupled to the detection device.

The system 1 according to the invention also has an electronic measurement, control, and evaluation unit 13 that is connected to the control unit 8 of the pump unit 6 via signal transmission means 14, which enables information and data to be exchanged on both sides. The electronic control, measurement, and evaluation unit 13 analyzes this information, which was transmitted as electrical signals from the detection device, and the computer program product stored on the electronic control, measurement, and evaluation unit 13 selects an algorithm for the operation of the first pump 7.1 on that basis. This algorithm defines, among other things, the change in current, voltage, or frequency and, in association therewith, the change in the speed of the second pump 7.2 and thus influences the training scenario.

### REFERENCE SYMBOLS

1 system

2 training model

3 anatomically modeled component

4 fluid circuit

5 fluid reservoir

6 pump unit

7.1 first pump

7.2 second pump

8 control unit

9 first feed

10 first return

11 first sensor

12 second sensor

13 electronic control, measurement, and evaluation unit

14 signal transmission means

15 direction of flow of the fluid

1. A system (1) for validation and training in invasive interventions in human and veterinary medicine, comprising
a training model (2) that is anatomically modeled on the human or animal body, having
an anatomical replica of a body part of the human or animal body having an opening, and
an anatomical replica of an interchangeable practice region that can be inserted into the opening of the anatomical replica of the body part and
has a front side that is accessible from the outside,
has a rear side that is at least partially connected in a form-fitting manner to the opening of the anatomical replica of the body part, and
comprises anatomically modeled components (3) such as at least one artificial blood vessel that are arranged in or on the interchangeable practice region,
a fluid circuit (4), having
at least one fluid reservoir (5) containing a fluid,
at least one pump unit (6) for generating a heartbeat and pulse based on the human cardiovascular system in the at least one artificial blood vessel, the pump unit (6) having at least one pump (7.1, 7.2) for conveying the fluid in the fluid circuit and the at least one artificial blood vessel and for simulating the blood flow and the pulse, and having a control unit (8) that is coupled to the at least one pump (7.1, 7.2),
a tube system, comprising
at least two first tubes, one end of each of which is detachably connected to the end of each of the at least one artificial blood vessel and the other end of each of which is detachably connected to the at least one pump (7.1, 7.2) of the pump unit (6) and serves as the first feed (9) and as the first return (10), and
at least one electronic control, measurement, and evaluation unit (13), characterized in that
the system (1) further comprises at least one detection device for monitoring the interventions in the interchangeable practice region, the at least one detection device being arranged in or on the anatomically modeled components (3) of the interchangeable practice region,
the system (1) being embodied such that
the detection device detects an interaction of the user with the anatomically modeled components (3) of the interchangeable practice region, and
the data generated by the interaction are transmitted as electrical signals via the signal transmission means (14) as feedback electrical signals to the electronic control, measurement, and evaluation unit (13), whereupon the electronic control, measurement, and evaluation unit (13) analyzes the data and, on that basis, transmits a scenario-dependent control signal via the signal transmission means (14) to the control unit (8) of the pump unit (8), whereby an autonomous reaction and control of the at least one pump unit (6) is carried out by increasing or decreasing the voltage, the current, or the frequency of the at least one pump (7.1, 7.2).

2. The system (1) according to claim 1, characterized in that the at least one pump (7.1, 7.2) of the pump unit (6) is embodied as a spiral pump, centrifugal pump, diaphragm pump, roller pump, shaking pump, water pump, or chain pump.

3. The system (1) according to claim 1, further comprising
at least one first sensor (11) that is independently selected from among a flow sensor, a pressure sensor, or a volume sensor and is arranged in or on the at least one artificial blood vessel and/or the tube system, and/or
at least one second sensor (12) that is embodied as a level sensor and arranged in or on the fluid reservoir (5),
the at least one first sensor (11) and/or the at least one second sensor (12) being connected to the control unit (8) of the pump unit (6) through signal transmission (14) and, in the event of damage to the at least one artificial blood vessel, measuring the change in the delivery rate or pressure of the fluid and/or the amount of the emerging fluid.

4. The system (1) according to claim 1, characterized in that the at least one detection device is arranged in or on the anatomically modeled component of the interchangeable practice region—which is embodied as at least one artificial blood vessel and/or anatomically modeled nerve tissue and/or anatomically modeled skin covering—and is embodied as an electrically conductive structure and/or as a light-guiding structure.

5. The system (1) according to claim 4, characterized in that the anatomically modeled skin covering is at least partially arranged on the interchangeable practice region, the anatomically modeled skin covering being composed at least in part of an elastic plastic, having a high level of resilience, and enabling a haptic perception of the at least one underlying artificial blood vessel.

6. The system (1) according to claim 1, characterized in that the fluid circuit (4) is embodied as a closed or an open fluid circuit.

7. A method for validation and training in invasive interventions in human and veterinary medicine using a system (1) according to claim 1, characterized in that
the detection device detects an interaction of the user with the anatomically modeled components (3) of the interchangeable practice region, and
subsequently, the data generated by the interaction are transmitted as electrical signals via the signal transmission means (14) as feedback electrical signals to the at least one electronic control, measurement, and evaluation unit (13), whereupon the electronic control, measurement, and evaluation unit (13) analyzes the data and, on that basis, transmits a scenario-dependent control signal via the signal transmission means (14) to the control unit (8) of the pump unit (6), whereby an autonomous reaction and control of the at least one pump unit (6) is carried out by increasing or decreasing the voltage, the current, or the frequency of the at least one pump (7.1, 7.2).

8. The method according to claim 7, wherein the amount of fluid emerging from the at least one artificial blood vessel is measured by the at least one first sensor (11) and/or the at least one second sensor (12) and transmitted as a feedback electrical signal via signal transmission means (14) to the electronic control, measurement, and evaluation unit (13), whereupon the electronic control, measurement, and evaluation unit (13) analyzes the data and, on that basis, transmits a scenario-dependent control signal via the signal transmission means (14) to the control unit (8) of the pump unit (6), whereby an autonomous reaction and control of the at least one pump unit (6) is carried out through an increase or a decrease in the voltage, the current, or the frequency of the at least one pump (7.1, 7.2).

9. The method according to claim 7, characterized in that the detection device detects an interaction of the user with the anatomically modeled components (3) of the interchangeable practice region, whereupon the data generated by the interaction are transmitted as electrical signals via the signal transmission means (14) to the control unit (8) of the pump unit (6), and the control unit (8) transmits the data as feedback electrical signals via signal transmission means (14) to the electronic control, measurement, and evaluation unit (13).

10. The method according to claim 7, characterized in that the feedback electrical signal is used to vary, monitor, and analyze the training progress as well as the pulse curve and the delivery rate in the fluid circuit (4) in real time.

11. The method according to claim 7, characterized in that the at least one artificial blood vessel and the amount of fluid flowing through can be felt as a pulse and/or the fluid emerging from the at least one artificial blood vessel collects under the skin covering and can be felt as a replica of an aneurysm.

12. A computer program product that is used to carry out the method according to claim 7.

13. An electronic control, measurement, and evaluation unit (13) on which the computer program product according to claim 12 is stored.

14. A use of a system (1) according to claim 1 for validation and training in invasive interventions in human and veterinary medicine.

15. A use of a computer program product according to claim 12 for validation and training in invasive interventions in human and veterinary medicine.

16. The method according to claim 7 for validation and training in invasive interventions in human and veterinary medicine.
